(19) United States
(12) Patent Application Publication
(10) Pub. No.: US 2021/0262473 A1
(43) Pub. Date: Aug. 26, 2021

(54) STRUCTURE CAPABLE OF TRANSFORMING ANY MOTOR VEHICLE INTO DRAINAGE PUMP VEHICLE

(71) Applicant: AMOS FLUID TECHNOLOGY CO., LTD., Ningguo (CN)

(72) Inventor: Haiqing MEI, Xuancheng (CN)

(73) Assignee: AMOS FLUID TECHNOLOGY CO., LTD., Ningguo (CN)

(21) Appl. No.: 17/053,739

(22) PCT Filed: Jul. 28, 2020
(86) PCT No.: PCT/CN2020/105025

§ 371 Date: Nov. 6, 2020

(30) Foreign Application Priority Data
Sep. 16, 2019 (CN) 201910870917.X

(51) Int. Cl. F04D 13/06; B62D 21/18; E02F 5/22; C02F 1/00

(52) U.S. Cl. CPC F04D 13/06; B62D 21/18; F04D 1/00; C02F 1/001; C02F 2201/008; E02F 5/22

(57) ABSTRACT

The utility model discloses a structure capable of transforming any motor vehicle into a drainage pump vehicle, comprising a motor vehicle, a chassis, a hydraulic pump/battery, a hydraulic hose/wire, a hydraulic motor/electric motor, a hydraulic oil tank, a pump, a lifting platform, and a quick water outlet connector. The motor vehicle is any motor vehicle powered by fuel or battery. The pump is any centrifugal pump or volumetric pump. The hydraulic motor/electric motor, the hydraulic hose/wire, the hydraulic oil tank, the pump, the lifting platform, and the quick water outlet connector are installed below the vehicle chassis. The pump is installed above the lifting platform, and forms a drainage working unit together with the lifting platform. In the utility model, without adding additional power, the space below the vehicle chassis and the power system of the vehicle are fully utilized, thereby improving the integration capability and function diversification of the motor vehicle, to maximize the functions of the motor vehicle with the smallest cost increase.

### TECHNICAL FIELD

The utility model relates to the field of motor vehicles, and particularly relates to a structure capable of transforming any motor vehicle into a drainage pump vehicle.

### BACKGROUND

Traditional motor vehicles generally have own specific purposes, and the development of composite functional capabilities is insufficient. The use space of a general vehicle or the transformation location of a special vehicle is mainly above a vehicle chassis, but the space below the vehicle chassis is rarely used, resulting in a waste of the space and the location. Meanwhile, a power system of the motor vehicle generally provides power to the motor vehicle, or provides hydraulic power to a brake system or a lifting system of the vehicle. The use efficiency of the power system of the vehicle is not fully developed and utilized, causing certain waste.

Therefore, it is conceived that without adding additional power, the space below the vehicle chassis and the power system of the vehicle are fully utilized, thereby improving the integration capability and function diversification of the motor vehicle, to maximize the functions of the motor vehicle with the smallest cost increase, thereby reducing the national investment in the field of emergency engineering vehicles, increasing the overall use efficiency of social vehicles, greatly increasing the availability of flood fighting rescue vehicles and greatly improving national emergency rescue capabilities.

### SUMMARY

The purpose of the utility model is to make improvements and innovations for the defects and problems in the background, and to provide a structure capable of transforming any motor vehicle into a drainage pump vehicle.

A technical solution adopted in the utility model is as follows:

A structure capable of transforming any motor vehicle into a drainage pump vehicle comprises a motor vehicle; the motor vehicle has a hydraulic pump/battery (in a vehicle head), a chassis; a hydraulic motor/electric motor, a hydraulic hose/wire, a hydraulic oil tank, a pump, a lifting platform, and a quick water outlet connector are installed below the vehicle chassis; the hydraulic motor/electric motor is coupled with the pump directly, the pump is installed above the lifting platform, and forms a drainage working unit together with the lifting platform; a drainage pump working unit is integrally installed below the vehicle chassis at the rear of the vehicle; when the vehicle is a fuel vehicle, the hydraulic oil tank is added to the fuel vehicle, and a fuel vehicle power system provides power to the hydraulic motor of the pump through the hydraulic pump and the hydraulic hose; and when the vehicle is an electric vehicle, a battery of the electric vehicle provides power to the electric motor of the pump through the wire.

The motor vehicle is any motor vehicle powered by fuel or battery.

The pump is any centrifugal pump or volumetric pump.

The lifting platform is connected to the vehicle chassis; and the lifting platform can vertically move up and down for adjusting the height of a water inlet of a drainage pump from the ground.

When the pump is installed vertically, the water inlet of the pump faces downward, a driving end faces upward, and a water outlet of the pump faces one side of a wheel; a pump body part penetrates downwards through the lifting platform; a filter cover is installed at a water inlet flange; a pump body is fixed on the lifting platform; a water outlet of the pump faces one side of a vehicle tire; and a water outlet flange is provided with a quick-fitting connector.

One or more pumps installed on the lifting platform can be installed according to the size of the pump and the size of a space below the vehicle chassis.

Compared with the prior art, the utility model has the technical effects:

In the utility model, without adding additional power, the space below the vehicle chassis and the power system of the vehicle are fully utilized, thereby improving the integration capability and function diversification of the motor vehicle, to maximize the functions of the motor vehicle with the smallest cost increase, thereby reducing the national investment in the field of emergency engineering vehicles, increasing the overall use efficiency of social vehicles, greatly increasing the availability of flood fighting rescue vehicles and greatly improving national emergency rescue capabilities.

### DESCRIPTION OF DRAWINGS

FIG. 1 is a top view in a structural schematic diagram of the utility model.

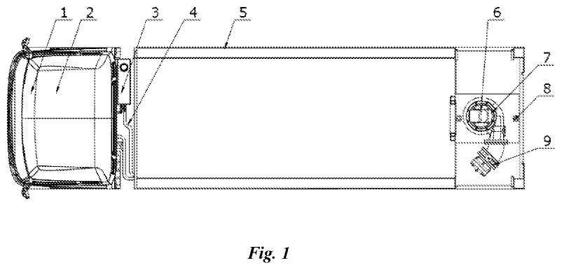

Wherein 1. hydraulic pump/battery (in a vehicle head); 2. motor vehicle; 3. hydraulic oil tank; 4. hydraulic hose/wire; 5. chassis; 6. hydraulic motor/electric motor; 7. pump; 8. lifting platform (electric/hydraulic); 9. quick water outlet connector;

FIG. 2 is a structural schematic diagram of application of the utility model on a vehicle model.

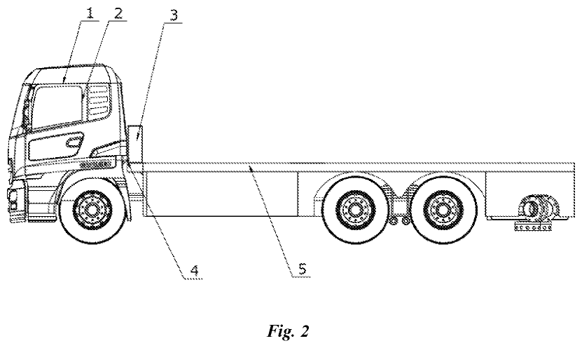

Wherein 1. hydraulic pump/battery (in a vehicle head); 2. motor vehicle; 3. hydraulic oil tank; 4. hydraulic hose/wire; 5. chassis;

FIG. 3 is a structural schematic diagram of application of the utility model on another vehicle model.

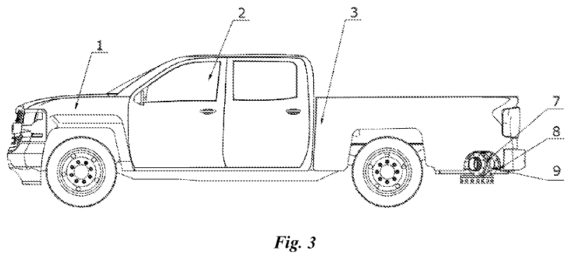

Wherein 1. hydraulic pump/battery (in a vehicle head); 2. motor vehicle; 3. hydraulic oil tank; 7. pump; 8. lifting platform (electric/hydraulic); 9. quick water outlet connector;

FIG. 4 is a rear view in a structural schematic diagram of the utility model.

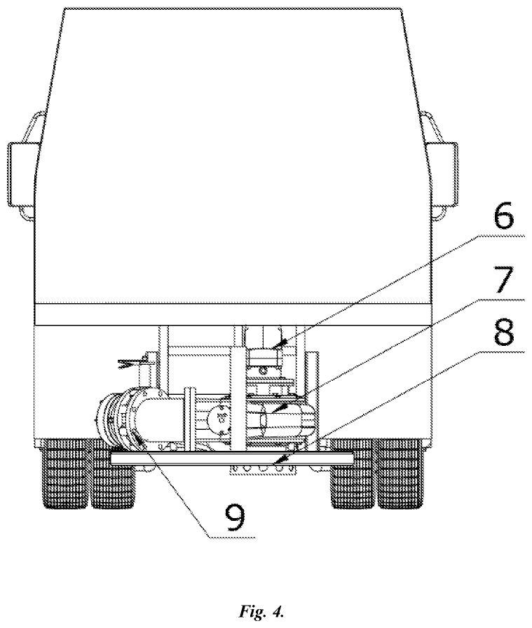

Wherein 6. hydraulic motor/electric motor; 7. pump; 8. lifting platform (electric/hydraulic); 9. quick water outlet connector.

### DETAILED DESCRIPTION

The utility model is further described below in detail in combination with the drawings and through embodiments.

A structure capable of transforming any motor vehicle into a drainage pump vehicle comprises a motor vehicle 2; the motor vehicle has a chassis 5; a hydraulic motor/electric motor 6, a hydraulic hose/wire 4, a hydraulic oil tank 3, a pump 7, a lifting platform 8, and a quick water outlet connector 9 are installed below the vehicle chassis; the hydraulic motor/electric motor is connected with the pump through the hydraulic hose/wire; the pump 7 is installed above the lifting platform 8, and forms a drainage working unit together with the lifting platform 8; a drainage pump working unit is integrally installed below the vehicle chassis 5 at the rear of the vehicle; when the vehicle is a fuel vehicle, the hydraulic oil tank 3 is added to the fuel vehicle, and a fuel vehicle power system's hydraulic pump 1 (in the vehicle head) provides power to the hydraulic motor 6 of the pump through the hydraulic hose 4; and when the vehicle is an electric vehicle, a battery 1 (in the vehicle head) of the electric vehicle provides power to the electric motor 6 of the pump through the wire 4. The motor vehicle is any motor vehicle powered by fuel or battery. The pump is any centrifugal pump or volumetric pump. The lifting platform is connected to the vehicle chassis; and the lifting platform can vertically move up and down for adjusting the height of a water inlet of a drainage pump from the ground. When the pump is installed vertically, the water inlet of the pump faces downward, a driving end faces upward, and a water outlet of the pump faces one side of a wheel; a pump body part penetrates downwards through the lifting platform; a filter cover is installed at a water inlet flange; a pump body is fixed on the lifting platform; a water outlet of the pump faces one side of a vehicle tire; and a water outlet flange is provided with a quick-fitting connector. One or more pumps installed on the lifting platform can be installed according to the size of the pump and the size of a space below the vehicle chassis.

The embodiments described in the utility model are only preferred embodiments of the utility model, and are not intended to limit the concept and the scope of the utility model. On the premise of not departing from the design idea of the utility model, various variations and improvements made to the technical solution of the utility model by those skilled in the art shall fall into the protection scope of the utility model. The technical contents claimed in the utility model have been fully recorded in the claims.

What is claimed is:

1. A structure capable of transforming any motor vehicle into a drainage pump vehicle, comprising a motor vehicle, characterized in that the motor vehicle has a hydraulic pump/battery (in a vehicle head), a chassis; a hydraulic motor/electric motor, a hydraulic hose/wire, a hydraulic oil tank, a pump, a lifting platform, and a quick water outlet connector are installed below the vehicle chassis; the hydraulic motor/electric motor is coupled with the pump directly, the pump is installed above the lifting platform, and forms a drainage working unit together with the lifting platform; a drainage pump working unit is integrally installed below the vehicle chassis at the rear of the vehicle; when the vehicle is a fuel vehicle, the hydraulic oil tank is added to the fuel vehicle, and a fuel vehicle power system provides power to the hydraulic motor of the pump through the hydraulic pump and the hydraulic hose; and when the vehicle is an electric vehicle, a battery of the electric vehicle provides power to the electric motor of the pump through the wire.

2. The structure capable of transforming any motor vehicle into the drainage pump vehicle according to claim 1, characterized in that the motor vehicle is any motor vehicle powered by fuel or battery.

3. The structure capable of transforming any motor vehicle into the drainage pump vehicle according to claim 1, characterized in that the pump is any centrifugal pump or volumetric pump.

4. The structure capable of transforming any motor vehicle into the drainage pump vehicle according to claim 1, characterized in that the lifting platform is connected to the vehicle chassis; and the lifting platform can vertically move up and down for adjusting the height of a water inlet of a drainage pump from the ground.

5. The structure capable of transforming any motor vehicle into the drainage pump vehicle according to claim 1, characterized in that when the pump is installed vertically, the water inlet of the pump faces downward, a driving end faces upward, and a water outlet of the pump faces one side of a wheel; a pump body part penetrates downwards through the lifting platform; a filter cover is installed at a water inlet flange; a pump body is fixed on the lifting platform; a water outlet of the pump faces one side of a vehicle tire; and a water outlet flange is provided with a quick-fitting connector.

6. The structure capable of transforming any motor vehicle into the drainage pump vehicle according to claim 1, characterized in that one or more pumps installed on the lifting platform can be installed according to the size of the pump and the size of a space below the vehicle chassis.
